(19) United States
(12) Patent Application Publication
(10) Pub. No.: US 2024/0127252 A1
(43) Pub. Date: Apr. 18, 2024

(54) RISK INSIGHTS UTILITY FOR TRADITIONAL FINANCE AND DECENTRALIZED FINANCE

(71) Applicant: SardineAI Corp., Miami, FL (US)

(72) Inventors: Ravindran Loganathan, Charlotte, NC (US); Michael Paul Ward, Brandon, FL (US); Srikant Rao, Pioneer, CA (US); Bino John Thomas, Saint Johns, FL (US); Kazuki Nishiura, Berkeley, CA (US)

(21) Appl. No.: 17/982,416

(22) Filed: Nov. 7, 2022

Related U.S. Application Data
(60) Provisional application No. 63/417,263, filed on Oct. 18, 2022.

(51) Int. Cl. G06Q 20/40

(52) U.S. Cl. CPC G06Q 20/4016

(57) ABSTRACT

The present technology provides solutions for determining transaction insights regarding a subject entity and on behalf of an inquiring entity. An exemplary method includes receiving an Application Programming Interface (API) communication calling an API, determining that the inquiring entity is permitted to access the transaction insights for the use case associated with the API, collecting data for the parameters in the defined in the API communication to yield collected data, analyzing the collected data to derive the transaction insights including at least one risk insight score and at least one reason code associated with the risk insight score, and providing a data pack of the transaction insights in a responsive communication to the inquiring entity.

### TECHNICAL FIELD

The present technology pertains to providing transaction insights to an inquiring entity by a service that evaluates transactions across a plurality of unrelated entities, and more particularly to providing transaction insights based on both on-chain and off-chain transactions to an inquiring entity with appropriate authorization and credentials to access protected and/or regulated information.

### BACKGROUND

Traditional financial institutions currently utilize various sources to determine whether to provide services to an individual or entity. These traditional financial institutions typically only have access to information pertaining to traditional financial transactions. Furthermore, certain types of information are only usable for specific types of inquiries, and therefore relevant information is not always utilized.

Additionally, the advent of various emerging financial technologies, such as blockchain technologies, cryptocurrencies, non-fungible tokens (NFTs), etc., are often not yet regulated. As such, access to transaction data and other information for these types of financial technologies may be limited. Due to limited access to these types of information, financial institutions are unable to make wholistic fraud or risk assessments.

Furthermore, it is likely that traditional finance (TradFi) and decentralized finance (DeFi) will coexist for the foreseeable future, such that end users (e.g., consumers and/or businesses) will utilize both types of financial products and services. However, there is an information gap between TradFi and DeFi that prevents both systems to efficiently deliver products and services to the end user and to protect against fraud.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1A illustrates a schematic block diagram of an example fraud insight system in accordance with some aspects of the present technology.

FIG. 1B illustrates a schematic block diagram of an example fraud insight system in accordance with some aspects of the present technology.

FIG. 2 illustrates a schematic flow diagram for an example workflow of a fraud insight system in accordance with some aspects of the present technology.

FIG. 3 illustrates an example method for determining transaction insights using an example fraud insight system in accordance with some aspects of the present technology.

FIG. 4 illustrates an example method for onboarding an inquiring entity in accordance with some aspects of the present technology.

FIG. 5 illustrates an example method for training an example machine learning model configured to receive transactional information and provide a risk score associated with the transactional information in accordance with some aspects of the present technology.

FIG. 6 illustrates a method for training a machine learning model in accordance with some aspects of the present technology.

FIG. 7 illustrates an example of a system for implementing certain aspects of the present technology in accordance with some aspects of the present technology.

### SUMMARY

In one aspect, the present technology can determine transaction insights regarding a subject entity and on behalf of an inquiring entity. The present technology includes receiving an Application Programming Interface (API) communication calling an API, where the API is specific to an associated use case for the transaction insights, the communication including parameters of inquiring entity data, subject entity data, access device data for an access device of the subject entity, and transaction data, determining that the inquiring entity is permitted to access the transaction insights for the use case associated with the API, collecting data for the parameters defined in the API communication to yield collected data, the collected data being of data types defined by a rule set associated with the use case, where the collected data of the data types defined in the rule set is collected across a network including a plurality of inquiring entities and databases, analyzing the collected data to derive the transaction insights including at least one risk insight score and at least one reason code associated with the risk insight score, and providing a data pack of the transaction insights in a responsive communication to the inquiring entity.

In another aspect, the present technology may also include includes onboarding the inquiring entity prior to receiving the API communication to associate the inquiring entity with permitted user use cases, the onboarding includes determining an identifier associated with the inquiring entity, the identifier including at least one of a routing number, an account number, an employer identification number, and a name of the inquiring entity, performing a lookup on the inquiring entity using the identifier in a database of regulated entities, and determining that the entity is a regulated entity when the entity appears in the database and that the entity is not a regulated entity when the entity does not appear in the database.

In another aspect, the present technology may also include where the inquiring entity is a regulated entity, where the database of regulated entities includes a first database of regulated entities and a second database of regulated entities, where the first database of regulated entities is correlated with a first use case and the second database of regulated entities is correlated with a second use case, the present technology further includes determining at least one permitted use case for the inquiring entity based on whether the inquiring entity is present in the first database of regulated entities or the second database of regulated entities, storing the permitted use case for the inquiring entity in an account database.

In another aspect, the present technology may also include where the API communication calling the API includes a session key, the session key identifying a customer identifier for the inquiring entity.

In another aspect, the present technology may also include where the determining that the inquiring entity is permitted to access the transaction insights for the use case associated with the API communication further includes extracting the customer identifier from the session key, confirming that the account database includes the permitted user case for the inquiring entity.

In another aspect, the present technology may also include where the data pack is customized to include selected data, and where some data can only be utilized for particular use cases.

In another aspect, the present technology may also include further includes training a machine learning model to receive past transactions on the network and to provide a respective risk score for each of the past transactions, the training includes inputting the past transactions into the machine learning model, inputting feedback information associated with each of the past transactions into the machine learning model, where the feedback information indicates a respective status for each of the past transactions, where the respective status indicates whether each of the past transactions was successful, returned, or fraudulent, and training the machine learning model to decrease the respective risk score for a particular transaction when the respective status indicates that the particular transaction is successful, and to maintain the respective risk score for the particular transaction when the respective status indicates that the particular transaction was returned, and to increase the respective risk score for the particular transaction when the respective status indicates that the particular transaction was fraudulent.

In another aspect, the present technology may also include where the plurality of inquiring entities and databases include at least one blockchain entity and one financial institution.

In another aspect, the present technology may also include further includes receiving, from the inquiring entity, a decision regarding the subject entity based at least in part on the data pack of transaction insights.

In another aspect, the present technology may also include where the transaction insights are provided via an appropriate legal framework determined based on the use case.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology. In some instances, well-known structures and devices are shown in block diagram form in order to facilitate describing one or more aspects. Further, it is to be understood that functionality that is described as being carried out by certain system components may be performed by more or fewer components than shown.

As discussed above, traditional financial institutions currently utilize various sources to determine whether to provide services to an individual or entity. These traditional financial institutions typically only utilize regulated, off-chain information. These various sources of information are used to assess the risk of providing one or more services to the requesting entity.

Furthermore, different entities (e.g., merchants, payment providers, processors, banks, etc.) would have varying amounts of insight into other types of transactions for a particular individual or entity. For example, a merchant would only have access to types of transaction information for individuals performing transactions with the merchant. As another example, a payment processor would only have access to types of transaction information for transactions utilizing that particular method of payment. As yet another example, banks would only have access to transactions occurring with financial products offered by the bank.

Additionally, detecting fraud is far more complicated than simply reviewing a user account. As the financial industry develops, there are constantly more and more diverse types of transactions (e.g., online purchases, in-store purchases, ACH transactions, bank transfers, deposits of checks, ATM withdrawals, trading of cryptocurrencies, etc.) performed by individuals. As such, there is a need in the art for aggregating the data spread across these various transaction types. However, aggregating data creates challenges of who can access what data and for what uses.

Certain types of information are only usable for specific types of inquiries. More specifically, there are various legal frameworks that govern access to different types of information. These legal frameworks include country-specific laws such as the Gramm-Leach-Bliley Act (GLBA), The Fair Credit Reporting Act (FCRA), Section 314(b) of the USA Patriot Act, General Data Protection Regulation (GDPR), etc. Each framework authorizes different entities to share, use, and/or access specific types of information for a given or specified use case. For example, the GLBA laws permit some financial institutions to access banking information to prevent (e.g., by verifying assets) fraud risks (e.g., account opening, funding, adding payment instrument(s), initiating a payment, other payment recipient risks, etc.). Other laws, such as the FCRA, may allow access to alternative and/or additional indicators (e.g., cash flow views that incorporate cross bank balances), while also only permitting financial institutions to access these types of data for valid needs (e.g., to consider an application with a creditor, insurer, employer, landlord, or other business). As another example, Section 314(b) of the USA Patriot Act permits financial institutions to share information with one another in order to identify and report to the federal government activities that may involve money laundering or terrorist activity.

As commerce becomes more globalized, additional country-specific laws become more relevant to day-to-day information. For example, the GDPR is a regulation in European Union (EU) law on data protection and privacy in the EU. Thus, usage and access of confidential, protected, and/or regulated information need to be properly provided to any inquiring entity.

Additionally, the advent of various emerging financial technologies, such as blockchain technologies, cryptocurrencies, non-fungible tokens (NFTs), etc., are often not yet regulated. As such, access to transaction data and other information for these types of financial technologies may be limited. Due to limited access to these types of information, financial institutions are unable to make wholistic fraud or risk assessments.

Furthermore, these emerging financial technologies are also globalized technologies, which further exacerbates the data privacy concerns that may eventually be governed by various different laws from different countries. As discussed above, it is likely that traditional finance (TradFi) and decentralized finance (DeFi) will coexist for the foreseeable future, such that end users (e.g., consumers and/or businesses) will utilize both types of financial products and services. Additionally, there is an information gap between TradFi and DeFi that prevents both systems to efficiently deliver products and services to the end user and to protect against fraud.

Accordingly, the present disclosure provides solutions for safely sharing both on-chain insights (e.g., on blockchain technologies) and off-chain insights (e.g., traditional transactions) of an entity to networks and institutions across the globe with the appropriate authorization and credentials to access such information. Additionally, the present disclosure provides solutions for maintaining partitions between various types of information, such that systems of the present technology are configured to ensure that no data will be delivered without proper authorization under a legal framework. For example, a system of the present technology can partition data, such that data only deliverable under FCRA will not be commingled with other data packs delivered under different use cases or legal frameworks.

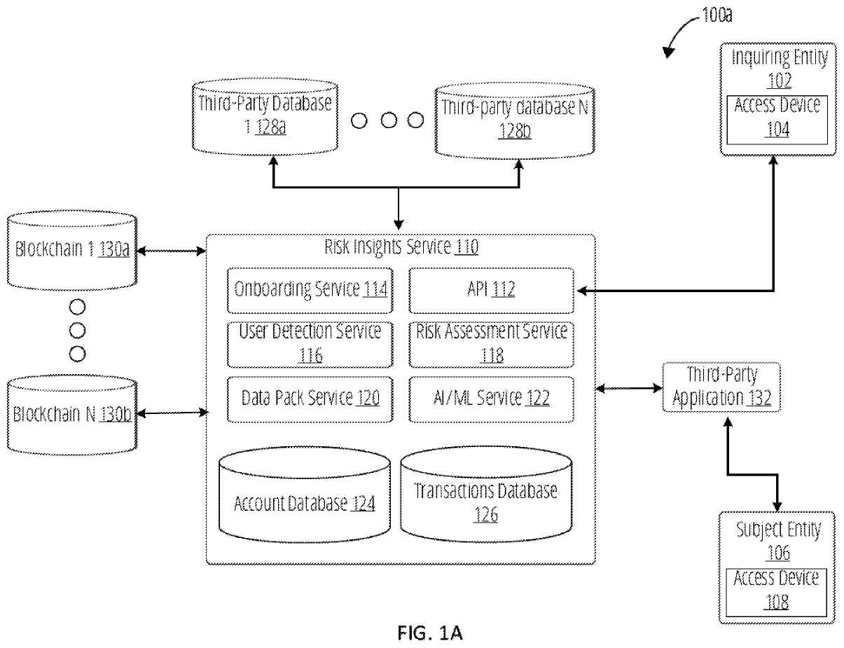

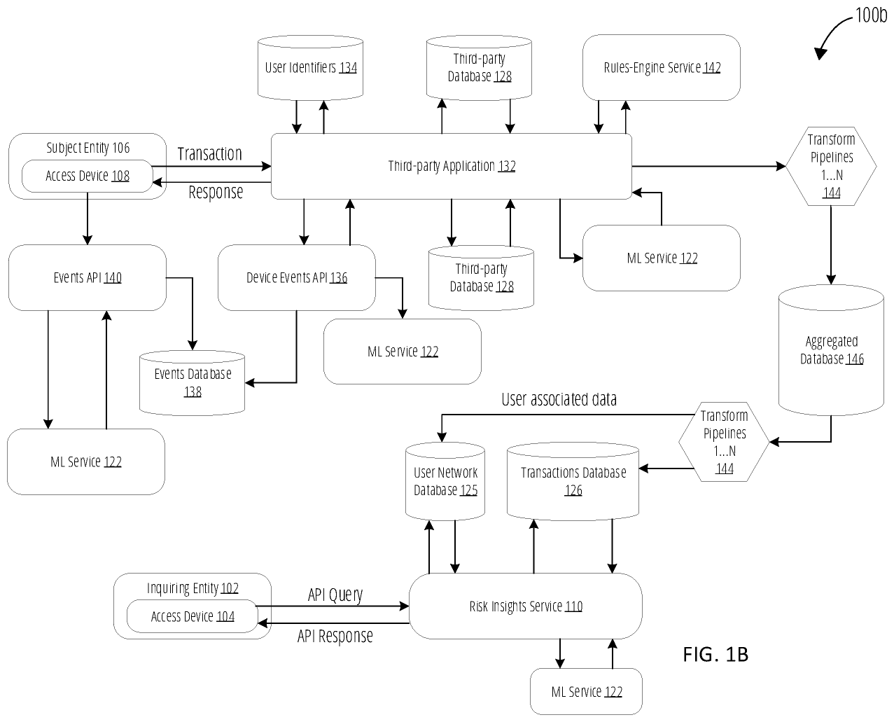

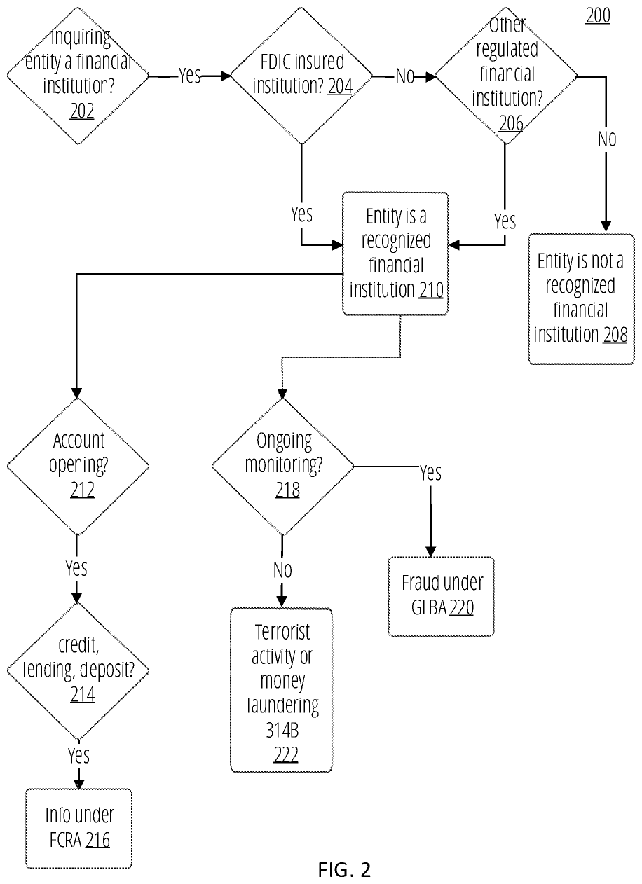

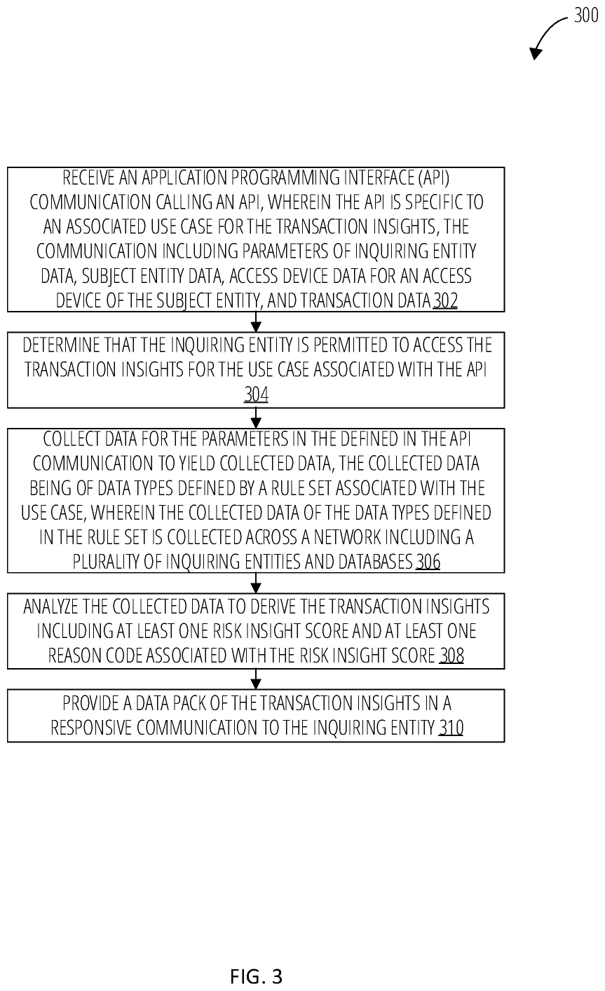

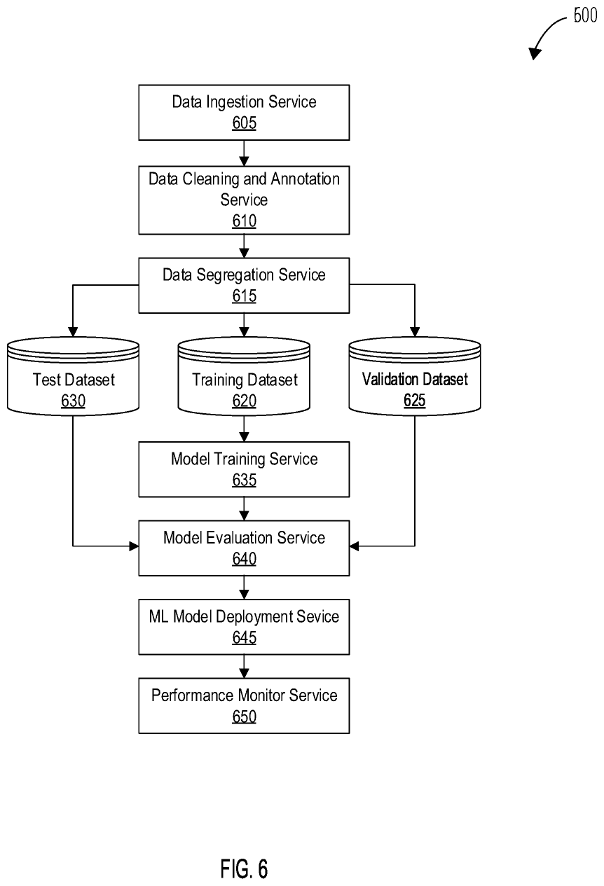

This disclosure now turns to FIGS. 1A and 1B, which describe example environments 100a, 100b (collectively environments 100) followed by an example workflow 200 for identifying a framework under which to provide information under in FIG. 2, various example methods 300, 400, 500 in FIGS. 3-5, and conclude with an example system for implementing the above in FIG. 6.

A networking environment 100a comprises an inquiring entity 102 utilizing an access device 104, a subject entity 106 using an access device 108, a risk insights service 110, third-party databases 128a and 128b (collectively third-party databases 128), blockchains 130a and 130b (collectively blockchains 130), one or more third-party applications 132.

Inquiring entities 102 can include entities that require information regarding a subject entity (e.g., subject entity 106). For example, an inquiring entity 102 may be a financial institution processing an application by the subject entity. As another example, an inquiring entity 102 may be a regulated institution required to monitor for potential fraud committed by the subject entity.

Subject entities 106 can include individuals and entities that conduct transactions. More specifically, subject entities 106 can perform or conduct on-chain transactions, off-chain transactions, and traditional transactions. On-chain transactions are transactions that occur on a blockchain (e.g., blockchains 130) that are reflected on a distributed, public ledger. On-chain transactions are typically validated and authenticated and lead to an update to the overall blockchain network. For example, a subject entity 106 may purchase a cryptocurrency on a crypto exchange. Off-chain transactions are transactions that occur outside of a blockchain. For example, a subject entity 106 may purchase a cryptocurrency wallet from another person, such that the value of the cryptocurrency is transferred to the subject entity 106, but the blockchain does not identify the transaction. Traditional transactions are transactions that are unrelated to blockchains, such as a credit card transaction at a merchant, depositing a check, an Automated Cleaning House (ACH) transaction to move money from one account to another, etc. For example, a subject entity 106 may purchase clothing with a credit card or debit card on a third-party website (e.g., a third-party application 132) that is associated with or otherwise connected to network environment 100a.

Third-party applications 132 are applications, websites, and/or services for entities or platforms (e.g., merchants, providers, payment processors, financial institutions, crypto exchanges, crypto wallets, etc.) associated with or otherwise connected to network environment 100a. For example, merchants typically have a website (e.g., a third-party application 132) that people can purchase goods on. As another example, people typically utilize a website or service of a crypto exchange to trade cryptocurrency.

Risk insights service 110 can include various modules and services that are leveraged to receive requests or inquiries from inquiring entities 102, process requests or inquiries, select appropriate data (e.g., for specific types of legal frameworks), package the selected data into data packs, and send the data packs to inquiring entities 102. More specifically, risk insights service 110 can include an Application Programming Interface (API) 112, an onboarding service 114, a user detection service 116, a risk assessment service 118, a data pack service 120, an AI/ML service 122, an account database 124, and one or more transactions databases 126. Although the various modules and services are shown as part of risk insights service 110, one of ordinary skill in the art would understand that the modules and services can be separate from risk insights service 110 without departing from the scope of the present disclosure. More specifically, each and every module and service can be a distinct module or service that is communication with risk insights service 110, such that risk insights service 110 can still leverage the modules and services.

API 112 is configured to interface with an access device 104 of inquiring entity 102. In some embodiments, API 112 can be configured to receive requests from inquiring entities 102. For example, API 112 can be configured to receive requests from inquiring entities 102 identifying a particular subject entity (e.g., subject entity 106). In some embodiments, the API 112 communications, calls, or requests can include different forms of information to identify the subject entity and/or the inquiring entity 102. For example, the requests or inputs can include a name, an address, an e-mail address, a phone number, a particular device, an Internet Protocol (IP) address, an account number, a routing number, card information, and/or cryptographic information (e.g., asset symbol, network, address, etc.) to identify a particular subject entity. In some embodiments, the API 112 requests can also include an inquiry period or look back period (e.g., past 90 days). API 112 can further be configured to generate a unique session key that identifies a customer identifier for the inquiring entity 102. In some embodiments, API 112 is configured to extract the customer identifier from the session key and confirm that account database 124 includes inquiring entity 102 and/or that inquiring entity 102 is permitted to access information for a use case identified in the API 112 communication. In some embodiments, API 112 is specific to an associated use case for the transaction insights, such that API 112 is configured to receive an API communication including parameters of inquiring entity data, subject entity data, access device data for an access device of the subject entity, and transaction data.

API 112 can further be configured to provide appropriate data (e.g., data packs generated by data pack service 120) to inquiring entities 102. API 112 can further be configured to receive feedback information from inquiring entities 102. The feedback information can include a decision rendered by inquiring entities 102 for a particular subject entity 106 associated with a previous inquiry. For example, the feedback information can identify that the inquiring entity 102 decided to approve an application by the subject entity 106 for a bank account. The feedback information can also identify a status of a transaction by the subject entity 106 with a particular entity. For example, an entity may identify that a transaction between the entity and the subject entity 106 was fraudulent (e.g., the subject entity 106 performed a chargeback on a credit card for a properly fulfilled transaction). Other statuses may include approval, denial, cancellation, settled, returned, disputed, fraud, suspected fraud, uncertain, and/or voided.

Onboarding service 114 is configured to onboard inquiring entities 102 to risk insights service 110. Onboarding service 114 can be configured to identify an identity of an inquiring entity 102. For example, an identifier may be associated with inquiring entity 102. An example identifier can include a routing number, an account number, an employer identification number, a name, etc. Onboarding service 114 can also be configured to look up an inquiring entity 102 using an identifier in a database (e.g., account database 124 and/or a database of regulated entities). Additionally, onboarding service 114 can be configured to assign or otherwise associate access to permitted information, permitted use cases, and/or permitted legal frameworks based on the identity of the inquiring entity 102. For example, one financial institution (e.g., an inquiring entity 102) may be associated with a permitted use case of credit checks for credit or lending decisions under FCRA. As another example, a cryptocurrency exchange platform (e.g., an inquiring entity 102 that is not a recognized or regulated financial institution) may be associated with access to and/or use cases only involving publicly available information.

User detection service 116 is configured to determine a particular user (e.g., subject entity) across multiple platforms and institutions. For example, user detection service 116 is configured to collect data from user devices and generate device fingerprints (e.g., to identify a particular user device), biometric fingerprints (e.g., to identify a particular user's behavior on a webpage), and information for profiles (e.g., to recognize information belonging to a particular user). User detection service 116 can utilize device fingerprints, biometric fingerprints, and information for profiles to determine when a transaction belongs to a particular user. For example, user detection service 116 can interpret device data (e.g., a Media Access Control (MAC) address of the device, an International Mobile Equipment Identity (IMEI), etc.) and sensor data (e.g., gyroscopic data, accelerometer data, etc.) from an access device 108 (e.g., a mobile phone) of a subject entity 106 to determine an extent of movement the subject entity performs when filling in data (e.g., how much a user's hand moves or shakes). Thus, as a particular user performs a transaction, whether through traditional financial institutions (e.g., via third-party applications 132) or through blockchains 130, user detection service 116 is configured to identify the transaction as belonging to the particular user and can store the transaction in transactions database 126. In some embodiments, user detection service 116 can utilize scripts or algorithms deployed on a third-party application or website (e.g., third-party applications 132) to capture the data described above.

Risk assessment service 118 is configured to assess risk for a particular transaction. More specifically, risk assessment service 118 can be configured to access transactions databases transactions database 126 to obtain transaction data. Risk assessment service 118 can then calculate a risk score for a particular transaction. For example, risk assessment service 118 can utilize various signals including, but not limited to, transactions from a particular location, Internet Protocol (IP) address, or other device or locational fingerprints (e.g., as determined by user detection service 116) during a past time period. In some embodiments, risk assessment service 118 can utilize a machine learning model configured to receive an inquiry identifying a subject entity (e.g., subject entity 106) and output a risk score calculated based on transaction insights for the subject entity (e.g., data obtained from transactions databases 126) and/or feedback information from inquiring entities 102 (e.g., a decision later rendered by an inquiring entity 102 for a particular inquiry associated with the subject entity). In some embodiments, risk assessment service 118 can aggregate risk scores for transactions associated with a particular subject entity (e.g., subject entity 106) to generate an aggregated risk score or reputation.

Data pack service 120 is configured to collect data from transactions database 126. Based on the use case and an associated legal framework, data pack service 120 can select data from transactions database 126 to include into a data pack and provide the data pack to inquiring entity 102. In some embodiments, multiple transactions database 126 may be present, such that each transactions database 126 only includes information that is classified for one or more use cases. Thus, data pack service 120 can collect information from selected transactions databases 126 that are classified for the relevant use case and/or associated legal framework. In some embodiments, data pack service 120 can be configured to identify and provide to an inquiring entity 102 (e.g., in a data pack to inquiring entity 102) a maximum risk level (e.g., during the inquiry period), an average risk level, a maximum risk score, an average risk score, a fraud indicator (e.g., whether fraud was identified in any transaction during the inquiry period), reason codes, number of third-parties that the subject entity has used, cryptographic wallets used by the subject entity, a first usage of a third-party associated with network 100a (e.g., the first time that a particular subject entity uses any third-party application 132 and/or third-party website associated with or connected to network 100a), device finger prints, behavioral biometrics, etc. Although data pack service 120 is shown in FIG. 1A as a service of risk insights service 110, it is to be understood that data pack service 120 can be a separate service from risk insights service 110. Additionally, risk insights service 110 can communicate and leverage data pack service 120 as a separate service.

AI/ML service 122 provides the infrastructure for training and evaluating machine learning models. Using AI/ML service 122, data scientists can prepare data sets; select, design, and train machine learning models; evaluate, refine, and deploy the models; maintain, monitor, and retrain the models; etc.

For example, training a machine learning model can include inputting past transactions into the machine learning model, inputting feedback information associated with each of the past transactions, and predicting a risk score for a particular transaction. More specifically, the feedback information can include a respective status for each of the past transactions, such that the respective status indicates whether each of the past transactions was successful, returned, or fraudulent. Then, AI/ML service 122 can be used to decrease the respective risk score for a particular transaction when the respective status indicates that the particular transaction is successful, and to maintain the respective risk score for the particular transaction when the respective status indicates that the particular transaction was returned, and to increase the respective risk score for the particular transaction when the respective status indicates that the particular transaction was fraudulent. Although shown as a part of risk insights service 110, it is to be understood that AI/ML service 122 can be separate from and communication with risk insights service 110.

Account database 124 can be configured to store account information for inquiring entities 102 and subject entities. For example, account database 124 can store identifiers of inquiring entities, permissions and/or use cases associated with inquiring entities 102, etc. In some embodiments, risk insights service 110 can perform a lookup on an inquiring entity 102 using an identifier associated with the inquiring entity 102 in account database 124. Additionally, account database 124 can be a database of regulated entities, such that only regulated entities are included in account database 124. In other words, an entity is a regulated entity when the entity appears in the database and the entity is not a regulated entity when the entity does not appear in the database. In some embodiments, multiple account databases 124 may be utilized, such that a first database of regulated entities is correlated with a first use case, a second database of regulated entities is correlated with a second use case, etc. Although shown as a part of risk insights service 110, it is to be understood that account database 124 can be separate from and communication with risk insights service 110. For example, risk insights service 110 can be configured to receive an API query (e.g., through API 112) from an inquiring entity 102. Risk insights service 110 can then communicate with and access account database 124 to determine whether inquiring entity 102 is a regulated entity (e.g., by attempting to match an identity of the inquiring entity with entries in account database 124 and determine a resolution therefrom).

Transactions database 126 can be configured to store transaction data for subject entities. More specifically, transactions database 126 can be configured to store both on-chain transaction data and off-chain transaction data. In some embodiments, multiple transactions databases 126 can be utilized, such that one subset of transactions databases 126 store on-chain transaction data and another subset of transactions databases 126 store off-chain transaction data. In some embodiments, transactions database 126 can collect and aggregate data from third-party databases 128 and blockchains 130. Furthermore, transactions database 126 can be configured to partition particular types of data (e.g., to prevent tainted data for a particular use case). For example, transactions database 126 may have a first partition for cryptographic transactions, a second partition for credit transactions, a third partition for cash transactions, etc. Furthermore, transactions database 126 can be configured to store various other types of data associated with subject entities including, but not limited to, the additional types discussed below, event data discussed below, etc.

Third-party databases 128 can be configured to store transaction data between a third-party (e.g., a merchant or store) and other entities (e.g., subject entities 106). For example, one merchant would have access to all transactions performed with the merchant. As another example, a credit card issuer, provider, or payment processor would have access to all transactions performed using the credit card. Third-party databases 128 can be in communication with risk insights service 110. In some embodiments, third-party databases 128 can also include additional data types associated with subject entities including, but not limited to, phone numbers, e-mail addresses, social security numbers, bank accounts, debit and/or credit card information, blockchain wallet addresses, etc. Furthermore, in some embodiments, third-party databases 128 can also store event data that extends beyond transactions. For example, third-party databases 128 can also store events performed by a subject entity including, but not limited to, linking a particular credit or debit card to an account, linking a bank account to another account, onboarding, etc. In some embodiments, third-party databases 128 are a part of risk insights service 110. In other embodiments, third-party databases 128 are separate from but in communication with risk insights service 110. Furthermore, it is to be understood that third-party databases 128 can also be and/or include third-party services. In other words, third-party databases 128 can instead be third-party services. Likewise, third-party databases 128 can include both third-party databases and third-party services.

Blockchains 130 are distributed ledgers that consists of growing lists of records that are securely linked together using cryptography. Each block in a blockchain contains a cryptographic hash of the previous block, a timestamp, and transaction data. Blockchains are used to enable cryptocurrencies, which are digital assets created using the cryptographic techniques of blockchains. Cryptocurrencies enable users to buy, sell, and/or trade the cryptocurrencies securely. Blockchains (and thus cryptocurrencies) can be accessed by crypto exchanges, in which users can exchange fiat currency for digital currency. In some embodiments, blockchains 130 are in communication with risk insights service 110. Similarly, in some embodiments, a third-party API can be utilized to gather on-chain data from blockchains 130. Additionally, risk insights service 110 can relate the on-chain data from blockchains 130 back to a particular subject entity of interest (e.g., via user detection service 116).

FIG. 1B illustrates an example network environment 100b that is another layout, architecture, and/or embodiment as network environment 100a. Network environment 100b risk insights service in communication with various services and modules. In this network environment 100b, the services and modules are separate from, but in communication with risk insights service, such that risk insights service can still communicate with and access the various different services, modules, and stores. One of ordinary skill in the art would understand that FIGS. 1A and 1B are two possible systems that can be modified without departing from the scope of the present technology. For example, some services and modules may be modified to be within risk insights service, while others are configured to be separate from risk insights service.

FIG. 1B illustrates an example network environment 100b, in which a subject entity 106 utilizes an access device 108 to access a third-party application 132 associated with a third party (e.g., a merchant, provider, payment processor, financial institution, crypto exchange, crypto wallet, etc.).

Third-party application 132 can be in communication with various databases and services. For example, third-party application can access one or more third-party databases 128, access user identifiers 134, include, deploy, and/or access a device events API 136, utilize and/or access a rules engine service 142, utilize and/or access ML service 122, and communicate with transform pipelines 144.

As discussed above, third-party databases 128 can be configured to store transaction events occurring at third-party application 132 (e.g., the website or mobile application of the third-party). For example, third-party databases 128 can be configured to store transaction event including, but not limited to, linking a card to an account with the third-party, linking a bank account to an account with the third-party, onboarding or activating an account with the third-party. In some embodiments, third-party databases 128 can be online aggregations of transactions occurring across multiple third parties.

User identifiers 134 can be stored in a database (e.g., third-party databases 128). User identifiers 134 can include phone numbers, e-mails, SSNs, bank account number, credit card number, blockchain wallets, etc. In other words, user identifiers 134 can include various different types of data that can identify and/or be linked to or associated with a particular user (e.g., subject entity 106).

Device events API 136 is configured to record biometric data (e.g., mouse movements, keyboard events, typing speed, movement of the device, etc.) while a subject entity 106 interacts with third-party application 132. In other words, device events API 136 is configured to record various device intelligence logics for behavioral biometrics. In some embodiments, device events API 136 can be a script or algorithm deployed on third-party application 132 that communicates with a user detection service (e.g., user detection service 116 as described above with respect to FIG. 1A). In some embodiments, device events API 136 can perform the functions of user detection service 116. Device events API 136 is further configured to provide data synchronously submitted to third-party application 132. For example, a subject entity 106 may be filling out a form. Device events API 136 can be configured to provide the recorded data, along with any inputted data (e.g., any data input into the form), to ML service 122 and/or an events database 138.

Events database 138 is configured to store the data recorded by device events API 136 and events API 140. In some embodiments, events database 138 is further configured to communicate with (e.g., send data to) user detection service 116.

Events API 140 is configured to record biometric data (e.g., mouse movements, keyboard events, typing speed, movement of the device, etc.). In some embodiments, events API 140 is an algorithm, script, or a software development kit (SDK) deployed on third-party application 132 and executed on or by access device 108. Additionally, events API 140 is configured to asynchronously receive biometric behavioral data and/or device intelligence data. Similarly, events API 140 is configured to asynchronously provide the biometric data and/or device intelligence data to events database 138. In some embodiments, events API 140 is also configured to provide the data to user detection service 116.

As described above, ML service 122 can be configured to receive data to train a ML model. More specifically, ML service 122 can be configured to receive the behavioral biometric data and/or device intelligence data (e.g., from device events API 136 and/or events API 140) to identify a particular user associated with the data. In some embodiments, the ML service 122 can be configured to support or be utilized by user detection service 116.

Rules engine service 142 is configured to select, change, and/or provide rules that identify specific types of data that are utilized to identify a particular subject entity 106. Furthermore, rules engine service 142 can provide rules that associate each type of data with a particular weight for determining a particular subject entity 106. For example, a first rule may associate a first weight for an IP address associated with access device 108 of subject entity 106, while a second rule may associate a second weight for biometric behavioral data (e.g., data obtained from device events API 136), such that the second weight is lower, higher, or the same weight as the first weight. Additionally, rules engine service 142 can provide rules that identify whether a particular transaction is likely to be fraudulent. For example, a rule may identify that abnormally frequent low transactions (e.g., a series of $2 transaction at a convenience store) and/or abnormally high transactions at particular merchants (e.g., $1,000 at a convenience store) may be indicators that the transaction is likely fraudulent. In some embodiments, rules engine service 142 can be configured to generate new rules. In some embodiments, rules engine service 142 can also be configured to receive input from third parties (e.g., merchants, providers, etc.) to automatically generate new rules. For example, a particular merchant may identify that a significantly high number of fraudulent transactions appear to originate from a particular country. Thus, rules engine service 142 may generate a rule that assigns a higher weight to data types indicative of geographical location (e.g., IP address, time of accessing third-party application 132, etc.).

Transform pipelines 144 are configured to transform data received from third-party applications 132 (e.g., to be properly stored in a database, to be utilized for machine learning, and/or to be provided to an inquiring entity). In some embodiments, transform pipelines 144 are configured to transform data to be stored in an aggregated database 146. In some embodiments, transform pipelines are configured to transform data to be stored in user network database 125 and/or transactions database 126.

Aggregated database 146 is configured to aggregate and store data from third-party applications 132. In other words, aggregated database 146 is configured to store data from multiple merchants, providers, payment processors, financial institutions, crypto exchanges, crypto wallets, etc. In some embodiments, aggregated database 146 can be a third-party database.

User network database 125 is configured to store user associated data. For example, user network database 125 can store various types of information associated with a particular subject entity 106. More specifically, user network database 125 can store and associate entity level device information, behavior biometrics, on-chain transaction data, off-chain transaction data, traditional transaction data, blockchain wallet addresses, and other customer information with a particular subject entity 106.

Similarly and as discussed above, transactions database 126 is configured to store transaction information. For example, transactions database 126 can be configured to store transaction data for subject entities. More specifically, transactions database 126 can be configured to store both on-chain transaction data and off-chain transaction data.

Furthermore, user network database 125 and transactions database 126 can be configured to partition particular types of data (e.g., to prevent tainted data for a particular use case). For example, transactions database 126 may have a first partition for cryptographic transactions, a second partition for credit transactions, a third partition for cash transactions, etc.

As discussed above, risk insights service 110 is configured to receive an API query from an access device 104 of an inquiring entity 102 and provide an API response. Risk insights service 110 can access appropriate data (e.g., for a use case identified in the API query and/or under a particular legal framework associated with the use case) in user network database 125 and transactions database 126, generate a data pack (e.g., using a ML model from ML service 122 and/or data pack service 120) with the appropriate data, and provide the data pack back to inquiring entity 102 in an API response.

FIG. 2 illustrates an example workflow 200 for identifying, determining, and/or selecting an appropriate legal framework (e.g., GLBA, FCRA, 314(b), GDPR, etc.) for a particular inquiry. Although the example workflow 200 depicts a particular sequence of operations, the sequence may be altered without departing from the scope of the present disclosure. For example, some of the operations depicted may be performed or in a different sequence that does not materially affect the function of workflow 200. In other examples, different components of an example device or system that implements workflow 200 may perform functions at substantially the same time or in a specific sequence. For example, the below disclosure is described as being performed by risk insights service 110. However, one of ordinary skill in the art would understand that other components, modules, or services (e.g., data pack service 120) can perform example workflow 200.

In some aspects, the workflow 200 can be performed when onboarding an inquiring entity 102 prior to the inquiring entity 102 making use of the risk insights service 110.

At step 202, risk insights service 110 can determine whether an inquiring entity 102 is a financial institution.

If inquiring entity 102 is a financial institution, risk insights service 110 can determine whether the inquiring entity 102 is a Federal Deposit Insurance Corporation (FDIC) insured institution at step 204. For example, risk insights service 110 can be configured to check a database (e.g., the BankFind Suite on the FDIC website) to determine whether the inquiring entity 102 is a FDIC insured institution.

If inquiring entity 102 is not a FDIC insured institution, at step 206, risk insights service 110 can determine if the inquiring entity 102 is an otherwise regulated financial institution.

If inquiring entity 102 is also not an otherwise regulated financial institution, risk insights service 110 determines that the inquiring entity 102 is not a recognized financial institution at step 208. In some embodiments, the workflow 200 ends at step 208. In some embodiments, risk insights service 110 may be configured to provide some information (e.g., publicly available information). In other words, risk insights service 110 can be configured to provide publicly available information to entities that are not regulated institutions. For example, inquiring entity 102 may be a blockchain based company that is not regulated but is concerned about potential fraudulent transactions. Risk insights service 110 can be configured to provide publicly available information to the blockchain based company. For example, risk insights service 110 can be configured to set access permissions (e.g., via onboarding service 114) for an account of the inquiring entity 102 (e.g., as stored and manipulated in account database 14) to be limited to publicly available information.

If inquiring entity 102 is determined by risk insights service 110 to be either an FDIC insured institution or an otherwise regulated financial institution, risk insights service 110 can determine that the inquiring entity 102 is a recognized financial institution at step 210.

At step 212, risk insights service 110 determines whether the inquiring entity 102 is permitted to request insights from risk insights service 110 for an account opening use case. For example, risk insights service 110 can be configured to perform a lookup in a database to determine whether the inquiring entity 102 is registered (e.g., performing a lookup on the U.S. Securities and Exchange Commission (SEC) database to determine whether the inquiring entity 102 is registered with the SEC).

If the inquiring entity 102 is permitted for account opening use cases, risk insights service 110 can further determine whether the account is associated with a credit, lending, or deposit decision at step 214.

If the inquiring entity 102 is not associated with a credit, lending, or deposit decision, the workflow 200 ends. As discussed above, in some embodiments, risk insights service 110 can be configured to still provide publicly available information even if the inquiring entity is not associated with a credit, lending, or deposit decision. For example, risk insights service 110 can be configured to set access permissions (e.g., via onboarding service 114) for an account of the inquiring entity 102 (e.g., as stored and manipulated in account database 14) to be limited to publicly available information.

At step 216, risk insights service 110 determines the applicable information or data and configures the account of the inquiring entity 102 at the risk insights service 110 to be permitted to receive a risk insights data pack that is compliant with FCRA from the risk insights service. For example, risk insights service 110 can be configured to set access permissions (e.g., via onboarding service 114) for the account of the inquiring entity 102 (e.g., as stored and manipulated in account database 124) to include access to data compliant with FCRA.

At step 218, risk insights service 110 determines whether the inquiring entity 102 is permitted to request insights from risk insights service 110 for an ongoing monitoring for fraud use case.

At step 220, risk insights service 110 determines the applicable information or data and configures the account of the inquiring entity at the risk insights service 110 to be permitted to receive a risk insights data pack that is compliant with the GLBA for ongoing monitoring for fraud. For example, risk insights service 110 can be configured to set access permissions (e.g., via onboarding service 114) for the account of the inquiring entity 102 (e.g., as stored and manipulated in account database 124) to include access to data compliant with GLBA.

At step 222, risk insights service 110 determines the applicable information or data and configures the account of the inquiring entity 102 at the risk insights service 110 to be permitted to receive a risk insights data pack that is compliant with the USA Patriot Act 314(b) to prevent fraud and/or money laundering. For example, risk insights service 110 can be configured to set access permissions (e.g., via onboarding service 114) for the account of the inquiring entity 102 (e.g., as stored and manipulated in account database 124) to include access to data compliant with the USA Patriot Act 314(b).

It is further considered that an inquiring entity can be associated with multiple use cases and access permissions. For example, an inquiring entity may be a FDIC insured financial institution that is associated with credit decisions and fraud monitoring. Thus, the inquiring entity may be granted access to data under FCRA, GLBA, and the USA Patriot Act 314(b) for a particular use case that is identified in an API communication. For example, a FDIC insured bank may regularly process account opening and lending decisions but may utilize an API request to risk insights service 110 inquiring about a particular subject entity to prevent money laundering. Thus, risk insights service 110 may be configured to only provide information that is compliant under the USA Patriot Act 314(b).

While the above description discusses FCRA, GLBA, and Section 314(b), it is to be understood that additional legal frameworks can be included in workflow 200 without departing from the scope of the present disclosure. Additional considerations or decision steps for country specific legal frameworks can be included to grand access to data under legal frameworks for specific countries. For example, a decision step can be added to determine whether the inquiring entity is in the EU and required to be compliant to EU laws (e.g., EU GDPR) and an action step can be added to associate the inquiring entity with data access compliant with the GDPR.

FIG. 3 illustrates an example method 300 for determining transaction insights regarding a subject entity and on behalf of an inquiring entity using an example fraud insight system. Although the example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements method 300 may perform functions at substantially the same time or in a specific sequence.

At step 302, method 300 includes receiving an application programming interface (API) communication calling an API 112, wherein the API 112 is specific to an associated use case for the transaction insights, the communication including parameters of inquiring entity data, subject entity data, access device data for an access device of the subject entity, and transaction data. For example, risk insights service 110 (e.g., via API 112) can receive an API communication calling an API.

At step 304, method 300 includes determining that the inquiring entity 102 is permitted to access the transaction insights for the use case associated with the API 112. For example, risk insights service 110 (e.g., via API 112, onboarding service 114, and/or data pack service 120) can determine that the inquiring entity 102 is permitted to access the transaction insights for the use case associated with the API 112.

At step 306, method 300 includes collecting data for the parameters defined in the API communication to yield collected data, the collected data being of data types defined by a rule set associated with the use case, wherein the collected data of the data types defined in the rule set is collected across a network including a plurality of inquiring entities and databases (e.g., transactions databases 126). For example, risk insights service 110 (e.g., via data pack service 120, transactions database 126, third-party databases 128, and/or blockchains 130) can collect data for the parameters defined in the API communication to yield collected data. As another example, the inquiring entity is a traditional financial institution (e.g., a bank), and the data types defined by a rule set associated with the use case (e.g., opening a bank account) includes blockchain data (e.g., trading of cryptocurrencies on a crypto exchange) and traditional transaction data (e.g., purchases with a credit card).

As yet another example, for an account opening use case, the rule set may associated with the account opening use case may permit various types of data such as a maximum risk level (e.g., during the inquiry period), an average risk level, a maximum risk score, an average risk score, a fraud indicator (e.g., whether fraud was identified in any transaction during the inquiry period), reason codes, number of third-parties that the subject entity has used, cryptographic wallets used by the subject entity, a first usage of a third-party associated with network 100 (e.g., the first time that a particular subject entity uses any third-party application 132 and/or third-party website associated with or connected to network 100), device finger prints, behavioral biometrics, etc.

As another example, for a lending or credit decision use case, the rule set associated with a lending or credit decision use case may include the above and additionally permit insight of bank account balances of the subject entity to determine credit risk. In other words, data regarding bank account balances may be a type of data that is applicable to some use cases and not others.

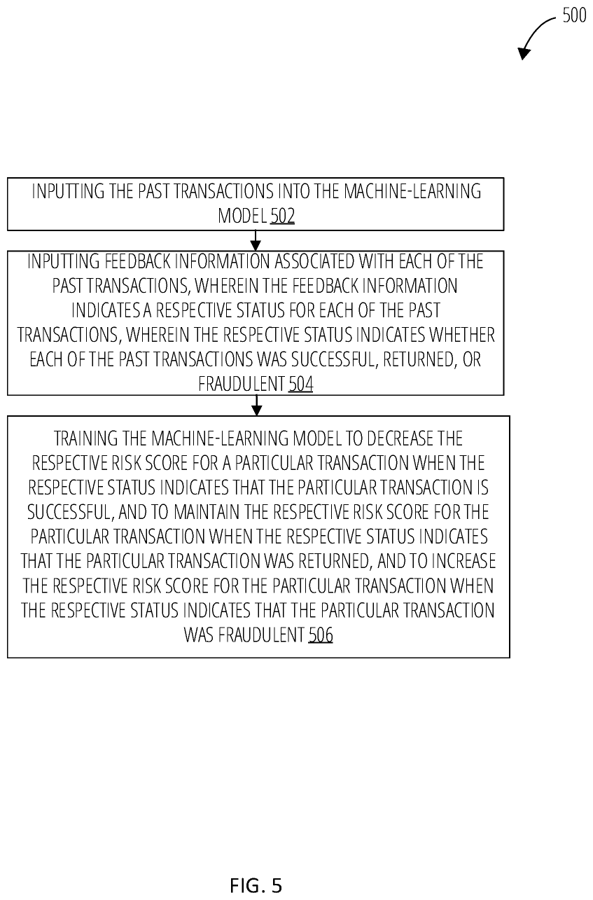

In some embodiments, method 300 includes analyzing the collected data to derive the transaction insights including at least one risk insight score and at least one reason code associated with the risk insight score at step 308. For example, risk insights service 110 (e.g., via risk assessment service) can analyze the collected data to derive the transactions insights. FIG. 5 describes a machine learning model and an example method for analyzing the collected data to derive a transaction insight.

At step 310, method 300 includes providing a data pack of the transaction insights in a responsive communication to the inquiring entity 102. For example, risk insights service 110 (e.g., via data pack service 120 and/or API 112) can provide the data pack of the transaction insights in a responsive communication to the inquiring entity 102.

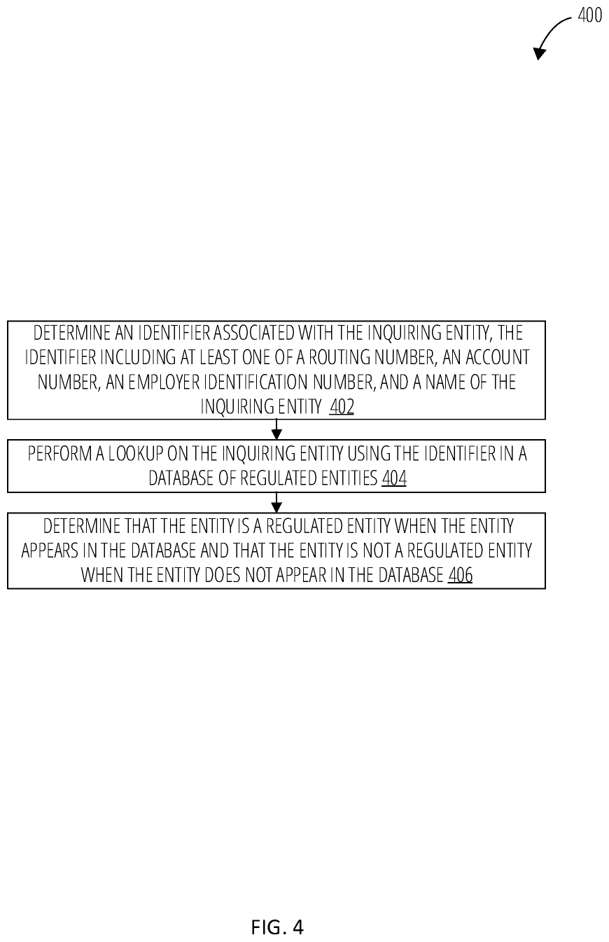

FIG. 4 illustrates an example method 400 for onboarding an inquiring entity 102 to an example risk insights service 110. Although the example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

As described above with respect to FIG. 2, risk insights service 110 can onboard an inquiring entity 102 (e.g., via onboarding service 114) by configuring an account of the inquiring entity 102. Method 400 provides additional details for how risk insights service 110 can onboard inquiring entity 102. It will be apparent that workflow 200 and method 400 can be utilized together to efficiently onboard inquiring entity 102.

Method 400 is directed to onboarding the inquiring entity 102 prior to receiving the API communication to associate the inquiring entity 102 with permitted use cases. For example, risk insights service 110 (e.g., API 112 and/or onboarding service 114) can onboard the inquiring entity 102 prior to receiving the API communication to associate the inquiring entity 102 with permitted use cases.

In some embodiments, method 400 includes determining an identifier associated with the inquiring entity 102, the identifier including at least one of a routing number, an account number, an employer identification number, and a name of the inquiring entity 102 at step 402. For example, risk insights service 110 (e.g., via API 112 and/or onboarding service 114) can determine an identifier associated with the inquiring entity 102.

In some embodiments, method 400 includes performing a lookup on the inquiring entity using the identifier in a database of regulated entities (e.g., account database 124) at step 404. For example, risk insights service 110 (e.g., via API 112 and/or onboarding service 114) can perform a lookup on the inquiring entity using the identifier in a database of regulated entities. For example, step 404 can include various decisions performed in workflow 200 including, but not limited to steps 202, 204, and 206.

In some embodiments, method 400 includes determining that the entity is a regulated entity when the entity appears in the database and that the entity is not a regulated entity when the entity does not appear in the database at step 406. For example, risk insights service 110 (e.g., via API 112 and/or onboarding service 114) can determine that whether the entity is a regulated entity based on whether the entity appears in the database. For example, step 406 can include various decisions performed in workflow 200 including, but not limited to steps 208 and 210.

It is further considered that method 400 can further utilize the additional decision and action steps performed in workflow 200 including, but not limited to steps 212, 214, 216, 218, 220, and 222. For example, method 400 can further include configuring accounts of inquiring entities based on determined permitted use cases, such as credit risk information under FCRA, ongoing account monitoring for fraud under GLBA, and fraud or money laundering prevention under Section 314(b).

FIG. 5 illustrates an example method 500 for training an example machine learning model configured to receive transactional information and provide a risk score associated with the transactional information. Although the example method 500 depicts a particular sequence of operations, the sequence may be altered without departing from the scope of the present disclosure. For example, some of the operations depicted may be performed in parallel or in a different sequence that does not materially affect the function of method 500. In other examples, different components of an example device or system that implements method 500 may perform functions at substantially the same time or in a specific sequence.

Method 500 is directed to training a machine learning model to receive past transactions on the network, associated with the network environment 100, and/or otherwise connected to the network environment 100 and to provide a respective risk score for each of the past transactions. For example, risk insights service 110 (e.g., via AI/ML service 122) can train a machine learning model to provide a respective risk score based on data from past transactions received from a network.

In some embodiments, method 500 includes inputting the past transactions into the machine learning model at step 502. For example, risk insights service 110 (e.g., via AI/ML service 122) can input the past transactions into the machine learning model. In some embodiments, risk insights service 110 can obtain (e.g., via access to third-party databases 128 and blockchains 130) transaction data from third-party websites and platforms (e.g., third-party application 132). It is further considered that risk insights service 110 can be configured to deploy an algorithm configured to capture usage data on third-party websites and platforms. For example, risk insights service 110 can be configured to deploy a script on the third-party website, such that the script is configured to capture mouse movements and keyboard inputs when a subject entity fills out a form on the third-party website. It is further considered that the past transactions can be aggregated from various different sources. For example, the past transactions can include transactions performed at banks (e.g., deposits and withdrawals) and transactions performed with merchants (e.g., purchasing goods and/or services with merchants). It is further considered that the past transactions can include other relevant data. For example, additional data can be included regarding methods or forms of payment, time of transactions, number of transactions performed by a particular subject entity during a particular period of time.

In some embodiments, method 500 includes inputting feedback information associated with each of the past transactions into the machine learning model, wherein the feedback information indicates a respective status for each of the past transactions, wherein the respective status indicates whether each of the past transactions was successful, returned, or fraudulent at step 504. For example, risk insights service 110 (e.g., via AI/ML service 122) can include inputting feedback information associated with each of the past transactions into the machine learning model.

In some embodiments, method 500 includes training the machine learning model to decrease the respective risk score for a particular transaction when the respective status indicates that the particular transaction is successful, and to maintain the respective risk score for the particular transaction when the respective status indicates that the particular transaction was returned, and to increase the respective risk score for the particular transaction when the respective status indicates that the particular transaction was fraudulent at step 506. For example, risk insights service 110 (e.g., via AI/ML service 122) can train the machine learning model to increase, maintain, and/or decrease the respective risk score for a particular transaction based on a respective status of the particular transaction. In some embodiments, the machine learning model may also be configured to provide a reason code attributed to one or more of the highest risk aspects. For example, a respective risk score indicating that a particular transaction is highly risky may also include a reason code indicating that the subject entity performing the particular transaction had performed a fraudulent chargeback for a recent purchase.

In some embodiments, the machine learning model can be trained with a loss function used to analyze error in the output. Any suitable loss function definition can be used, such as Cross-Entropy loss. Another example of a loss function includes the mean squared error (MSE), defined as E_total=Σ(1/2 (target-output)\hat{ }2). The loss can be set to be equal to the value of E_total. The loss (or error) will be high for the initial training data since the actual values will be much different than the predicted output. The goal of training is to minimize the amount of loss so that the predicted output is the same as the training output. The machine learning model can perform a backward pass by determining which inputs (weights) most contributed to the loss of the model, and can adjust the weights so that the loss decreases and is eventually minimized.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 6 illustrates an example lifecycle 600 of a ML model in accordance with some examples. The first stage of the lifecycle 600 of a ML model is a data ingestion service 605 to generate datasets described below. ML models require a significant amount of data for the various processes described in FIG. 6 and the data persisted without undertaking any transformation to have an immutable record of the original dataset. The data can be provided from third party sources such as publicly available dedicated datasets. The data ingestion service 605 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data from the consumer of the data (e.g., an ML model training pipeline). For offline data production, when source data is available from the producer, the producer publishes a message and the data ingestion service 605 retrieves the data. In some examples, the data ingestion service 605 may be online and the data is streamed from the producer in real-time for storage in the data ingestion service 605.

After data ingestion service 605, a data preprocessing service preprocesses the data to prepare the data for use in the lifecycle 600 and includes at least data cleaning, data transformation, and data selection operations. The data preprocessing service 610 removes irrelevant data (data cleaning) and general preprocessing to transform the data into a usable form. The data preprocessing service 610 includes labelling of features relevant to the ML model. In some examples, the data preprocessing service 610 may be a semi-supervised process performed by a ML to clean and annotate data that is complemented with manual operations such as labeling of error scenarios, identification of untrained features, etc.

After the data preprocessing service 610, data segregation service 615 to separate data into at least a training dataset 620, a validation dataset 625, and a test dataset 630. Each of the training dataset 620, a validation dataset 625, and a test dataset 630 are distinct and do not include any common data to ensure that evaluation of the ML model is isolated from the training of the ML model.

The training dataset 620 is provided to a model training service 635 that uses a supervisor to perform the training, or the initial fitting of parameters (e.g., weights of connections between neurons in artificial neural networks) of the ML model. The model training service 635 trains the ML model based a gradient descent or stochastic gradient descent to fit the ML model based on an input vector (or scalar) and a corresponding output vector (or scalar).

After training, the ML model is evaluated at a model evaluation service 640 using data from the validation dataset 625 and different evaluators to tune the hyperparameters of the ML model. The predictive performance of the ML model is evaluated based on predictions on the validation dataset 625 and iteratively tunes the hyperparameters based on the different evaluators until a best fit for the ML model is identified. After the best fit is identified, the test dataset 630, or holdout data set, is used as a final check to perform an unbiased measurement on the performance of the final ML model by the model evaluation service 640. In some cases, the final dataset that is used for the final unbiased measurement can be referred to as the validation dataset and the dataset used for hyperparameter tuning can be referred to as the test dataset.

After the ML model has been evaluated by the model evaluation service 640, a ML model deployment service 645 can deploy the ML model into an application or a suitable device. The deployment can be into a further test environment such as a simulation environment, or into another controlled environment to further test the ML model.

After deployment by the ML model deployment service 645, a performance monitor 650 monitors for performance of the ML model. In some cases, the performance monitor service 650 can also record additional transaction data that can be ingested via the data ingestion service 605 to provide further data, additional scenarios, and further enhance the training of ML models.

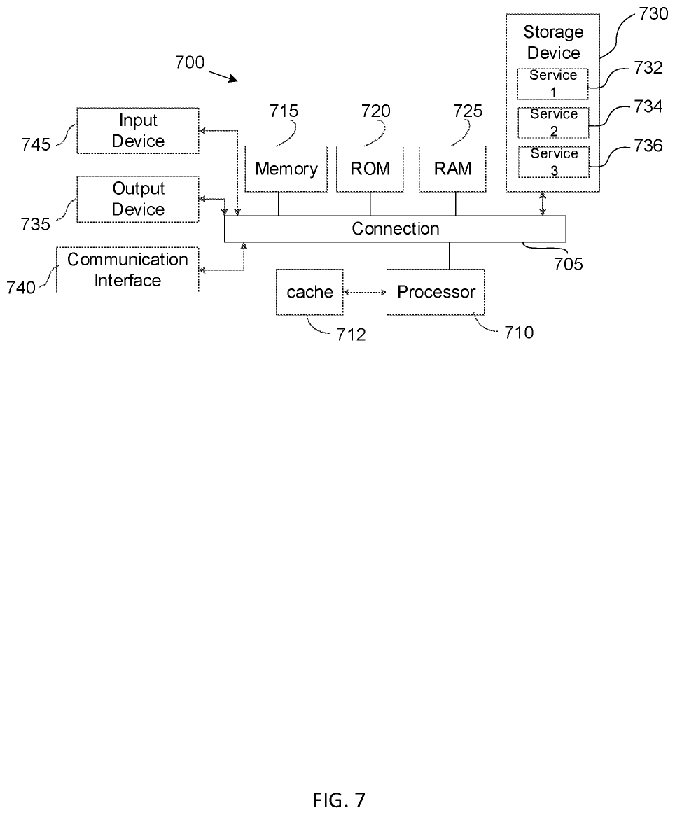

FIG. 7 shows an example of computing system 700, which can be for example any computing device making up risk insights service 110, access device 104, access device 108, third party application 132, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710.

Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement, and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances, the present technology may be presented as including individual functional blocks including functional blocks comprising devices, device components, steps or methods in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method of determining transaction insights regarding a subject entity and on behalf of an inquiring entity, the method comprising:
receiving an Application Programming Interface (API) communication calling an API, wherein the API is specific to an associated use case for the transaction insights, the communication including parameters of inquiring entity data, subject entity data, access device data for an access device of the subject entity, and transaction data;
determining that the inquiring entity is permitted to access the transaction insights for the use case associated with the API;
collecting data for the parameters defined in the API communication to yield collected data, the collected data being of data types defined by a rule set associated with the use case, wherein the collected data of the data types defined in the rule set is collected across a network including a plurality of inquiring entities and databases;
analyzing the collected data to derive the transaction insights including at least one risk insight score and at least one reason code associated with the risk insight score; and
providing a data pack of the transaction insights in a responsive communication to the inquiring entity.

2. The method of claim 1, comprising:
onboarding the inquiring entity prior to receiving the API communication to associate the inquiring entity with permitted user use cases, the onboarding comprising:
determining an identifier associated with the inquiring entity, the identifier including at least one of a routing number, an account number, an employer identification number, and a name of the inquiring entity;
performing a lookup on the inquiring entity using the identifier in a database of regulated entities; and
determining that the entity is a regulated entity when the entity appears in the database and that the entity is not a regulated entity when the entity does not appear in the database.

3. The method of claim 2, wherein the inquiring entity is a regulated entity, wherein the database of regulated entities includes a first database of regulated entities and a second database of regulated entities, wherein the first database of regulated entities is correlated with a first use case and the second database of regulated entities is correlated with a second use case, the method further comprising:
determining at least one permitted use case for the inquiring entity based on whether the inquiring entity is present in the first database of regulated entities or the second database of regulated entities; and
storing the permitted use case for the inquiring entity in an account database.

4. The method of claim 1, wherein the inquiring entity is a traditional financial institution, and wherein the data types defined by the rule set associated with the use case include blockchain data and traditional transaction data.

5. The method of claim 1, wherein the API communication calling the API includes a session key, the session key identifying a customer identifier for the inquiring entity.

6. The method of claim 5, wherein the determining that the inquiring entity is permitted to access the transaction insights for the use case associated with the API communication further comprises:
extracting the customer identifier from the session key; and
confirming that an account database includes a permitted user case for the inquiring entity.

7. The method of claim 1, wherein the data pack is customized to include selected data, and wherein some data can only be utilized for particular use cases.

8. The method of claim 1, further comprising:
training a machine learning model to receive past transactions on the network and to provide a respective risk score for each of the past transactions, the training comprising:
inputting the past transactions into the machine learning model;
inputting feedback information associated with each of the past transactions into the machine learning model, wherein the feedback information indicates a respective status for each of the past transactions, wherein the respective status indicates whether each of the past transactions was successful, returned, or fraudulent; and
training the machine learning model to decrease the respective risk score for a particular transaction when the respective status indicates that the particular transaction is successful, and to maintain the respective risk score for the particular transaction when the respective status indicates that the particular transaction was returned, and to increase the respective risk score for the particular transaction when the respective status indicates that the particular transaction was fraudulent.

9. The method of claim 1, wherein the plurality of inquiring entities and databases include at least one blockchain entity and one financial institution.

10. The method of claim 1, further comprising:
receiving, from the inquiring entity, a decision regarding the subject entity based at least in part on the data pack of transaction insights.

11. The method of claim 1, wherein the transaction insights are derived based only on collected data of the data types permitted by a specific legal framework selected based on the use case.

12. A non-transitory computer-readable storage medium storing instructions thereon, wherein the instructions, when executed by a computer, cause the computer to:
receive an Application Programming Interface (API) communication calling an API, wherein the API is specific to an associated use case for transaction insights, the communication including parameters of inquiring entity data, subject entity data, access device data for an access device of the subject entity, and transaction data;
determine that the inquiring entity is permitted to access the transaction insights for the use case associated with the API;
collect data for the parameters defined in the API communication to yield collected data, the collected data being of data types defined by a rule set associated with the use case, wherein the collected data of the data types defined in the rule set is collected across a network including a plurality of inquiring entities and databases;
analyze the collected data to derive the transaction insights including at least one risk insight score and at least one reason code associated with the risk insight score; and
provide a data pack of the transaction insights in a responsive communication to the inquiring entity.

13. The non-transitory computer-readable storage medium of claim 12, wherein the instructions, when executed by the computer, further cause the computer to:
onboard the inquiring entity prior to receiving the API communication to associate the inquiring entity with permitted user use cases, the onboarding comprising:
determine an identifier associated with the inquiring entity, the identifier including at least one of a routing number, an account number, an employer identification number, and a name of the inquiring entity;
perform a lookup on the inquiring entity using the identifier in a database of regulated entities; and
determine that the entity is a regulated entity when the entity appears in the database and that the entity is not a regulated entity when the entity does not appear in the database.

14. The non-transitory computer-readable storage medium of claim 12, wherein the inquiring entity is a regulated entity, wherein the database of regulated entities includes a first database of regulated entities and a second database of regulated entities, wherein the first database of regulated entities is correlated with a first use case and the second database of regulated entities is correlated with a second use case, wherein the instructions further configure the computer to:
determine at least one permitted use case for the inquiring entity based on whether the inquiring entity is present in the first database of regulated entities or the second database of regulated entities; and
store the permitted use case for the inquiring entity in an account database.

15. The non-transitory computer-readable storage medium of claim 12, wherein the inquiring entity is a traditional financial institution, and wherein the data types defined by the rule set associated with the use case include blockchain data and traditional transaction data.

16. A system comprising:
a processor; and
a non-transitory memory storing instructions that, when executed by the processor, cause the processor to:
receive an Application Programming Interface (API) communication calling an API, wherein the API is specific to an associated use case for transaction insights, the communication including parameters of inquiring entity data, subject entity data, access device data for an access device of the subject entity, and transaction data;
determine that the inquiring entity is permitted to access the transaction insights for the use case associated with the API;
collect data for the parameters defined in the API communication to yield collected data, the collected data being of data types defined by a rule set associated with the use case, wherein the collected data of the data types defined in the rule set is collected across a network including a plurality of inquiring entities and databases;
analyze the collected data to derive the transaction insights including at least one risk insight score and at least one reason code associated with the risk insight score; and
provide a data pack of the transaction insights in a responsive communication to the inquiring entity.

17. The system of claim 16, wherein the API communication call the API includes a session key, the session key identifying a customer identifier for the inquiring entity.

18. The system of claim 17, wherein determining that the inquiring entity is permitted to access the transaction insights for the use case associated with the API communication further comprises:
extracting the customer identifier from the session key; and
confirming that an account database includes a permitted user case for the inquiring entity.

19. The system of claim 16, wherein the instructions further cause the processor to:
train a machine learning model to receive past transactions on the network and to provide a respective risk score for each of the past transactions, the training comprising:
inputting the past transactions into the machine learn model;
inputting feedback information associated with each of the past transactions into the machine learn model, wherein the feedback information indicates a respective status for each of the past transactions, wherein the respective status indicates whether each of the past transactions was successful, returned, or fraudulent; and
train the machine learning model to decrease the respective risk score for a particular transaction when the respective status indicates that the particular transaction is successful, and to maintain the respective risk score for the particular transaction when the respective status indicates that the particular transaction was returned, and to increase the respective risk score for the particular transaction when the respective status indicates that the particular transaction was fraudulent.

20. The system of claim 16, wherein the instructions further configure cause the processor to:
receive, from the inquiring entity, a decision regarding the subject entity based at least in part on the data pack of transaction insights.
